(19) United States
(12) Patent Application Publication
(10) Pub. No.: US 2008/0184709 A1
(43) Pub. Date: Aug. 7, 2008

(54) TURBINE POWER GENERATION USING LIGNIN-BASED FUEL

(76) Inventor: DEAN W. ROWELL, Salt Lake City, UT (US)

Correspondence Address: FOX ROTHSCHILD LLP;PRINCETON PIKE CORPORATE CENTER, 997 LENOX DRIVE, BUILDING #3, LAWRENCEVILLE, NJ, 08648, US

(21) Appl. No.: 11/672,265

(22) Filed: Feb. 7, 2007

(51) Int. Cl. F02C 3/00; C10L 5/44

(52) U.S. Cl. 60/776; 44/307

(57) ABSTRACT

A method of generating power and a fuel for use in a gas turbogenerator power system are disclosed. The method comprises injecting lignin residue derived from the enzymatic hydrolysis of a biomass feedstock and natural gas into a combustor of a gas turbine power generator; combusting the lignin residue and natural gas with compressed air; inputting the resultant gases into a gas turbine to rotate a turbine shaft and generate rotational energy; and converting the rotational energy into electrical energy. The lignin residue is preferably derived from a process of simultaneous sachrification and fermentation of the biomass feedstock. The lignin residue is preferably transported to the combustor in a pipeline with pressurized air. The fuel comprises a mixture of lignin residue derived from the enzymatic hydrolysis of a biomass feedstock and natural gas. Preferably, the lignin residue is derived from a process for the simultaneous sachrification and fermentation of the biomass feedstock. The lignin residue comprises about 2 to about 70 percent, preferably about 25 to about 65 percent, most preferably about 40 to about 60 percent, by weight of the total amount of lignin residue and natural gas in the mixture.

### BACKGROUND OF THE INVENTION

1. Field of the Invention

The present invention relates to a method and apparatus of generating power using natural gas and the lignin byproduct of enzymatic simultaneous saccharification and fermentation (SSF) of biomass feedstocks.

2. Description of Related Art

Various methods have been proposed to produce ethanol from biomass cellulosic materials such as paper, cardboard, wood and other fibrous plant materials. These cellulosic materials comprise cellulose, hemicellulose and lignin. Ethanol is produced by hydrolysis and fermentation of the sugars in the cellulose and hemicellulose. The lignin which contains no sugars encloses the cellulose and hemicellulose molecules and impedes the conversion of the sugars into ethanol. Methods of producing ethanol from biomass include, for example, pretreatment of the cellulosic material to dissociate the cell components followed by a conversion process to convert the sugars into ethanol.

Numerous pretreatment methods or combinations of methods are available. Physical pretreatments such as milling or steam processing break down the biomass feedstock size. Chemical pretreatment methods such as the use of dilute acid, alkaline or other chemicals may also be employed. After pretreatment, the most commonly used hydrolysis methods are acid hydrolysis (either dilute or concentrated) processes which only require a reduction of particle size as a sole pretreatment. Enzymatic processes require a vigorous pretreatment similar to those described above. FIG. 1 illustrates a schematic representation of the steps in four cellulose production processes as developed by ENEA (arrow A), BC International (arrow B), Alkenol (arrow C), and National Renewable Energy Laboratory (NREL) (arrow D).

The “lignin” residue generated by these ethanol production processes varies in composition depending upon the ethanol production process and the feedstock employed. The residue, while commonly referred to as “lignin” is really a mixture of lignin, unhydrolyzed cellulose, yeast or other bacteria cell mass, and other non-volatile dissolved chemicals. This lignin residue may have a range of heating values and combustion characteristics depending upon the residue composition and moisture content resulting from the selected ethanol production process. Typically, it has been suggested that this residue be combusted in a fluidized-bed or grate type boiler to produce steam for use in the ethanol production process or for use in producing electricity through a multistage steam turbogenerator.

U.S. Pat. Nos. 6,855,180 and 6,878,212 to Pinatti et al. disclose a process for the production of a cellulignin fuel. The biomass material is subjected to a prehydrolysis acid treatment. The prehydrolysis treatment comprises filling a reactor with biomass and a pre-heated acidic solution, heating, pressurizing the contents with rotary oscillation. The resulting pre-hydrolyzate liquid is separated for further sugar-recovery processing. The solid cellulignin byproduct is washed and recovered. Since the biomass material has not undergone hydrolysis, the cellulignin byproduct retains a significant portion of the cellulose and/or hemicellulose fractions. In fact, so much cellulosic material is retained that it is taught that the resultant byproduct may be used as animal forage having digestibility comparable or superior to wet maize silage, alfalfa silage, grass forage and oat straw. To prepare the cellulignin byproduct for use as a fuel, the material is further processed by grinding to obtain the necessary particulate size, passing the ground particulate through a cyclone to separate undesirably large particles, and passing the ground particulate through a magnetic separator to remove metallic contamination originated from the grinders.

### BRIEF SUMMARY OF THE INVENTION

A method of generating power is disclosed. The method comprises injecting lignin residue derived from the enzymatic hydrolysis of a biomass feedstock and natural gas into a combustor of a gas turbine power generator; combusting the lignin residue and natural gas with compressed air; inputting the resultant gases into a gas turbine to rotate a turbine shaft and generate rotational energy; and converting the rotational energy into electrical energy. The lignin residue is preferably derived from a process of simultaneous sachrification and fermentation of the biomass feedstock. The lignin residue is preferably transported to the combustor in a pipeline with pressurized air.

A fuel for use in a gas turbogenerator power system is disclosed. The fuel comprises a mixture of lignin residue derived from the enzymatic hydrolysis of a biomass feedstock and natural gas. Preferably, the lignin residue is derived from a process for the simultaneous sachrification and fermentation of the biomass feedstock. The lignin residue comprises about 2 to about 70 percent, preferably about 25 to about 65 percent, most preferably about 40 to about 60 percent, by (weight) of the total amount of lignin residue and natural gas in the mixture.

### BRIEF DESCRIPTION OF THE DRAWINGS

FIG. 1 is a schematic diagram of the overall process steps of four different processes for producing ethanol from cellulosic material.

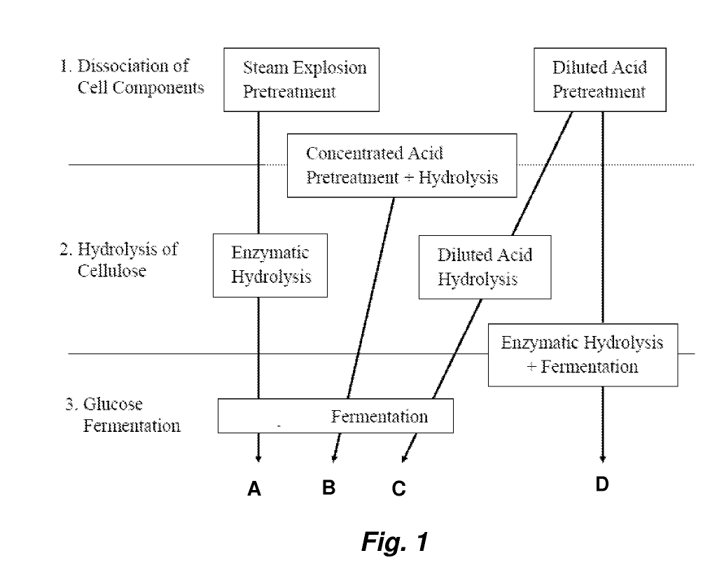

FIG. 2 is a schematic diagram of a dilute acid/simultaneous saccharification and fermentation process for producing ethanol from cellulosic material developed by NREL.

FIG. 3 is a process flow diagram illustrating the sub-processes and relationships between sub-processes in the NREL SSF process.

FIG. 4 is a schematic diagram of a typical gas turbogenerator power system in which mixture of lignin residue and natural gas may be used to produce electrical energy.

### DETAILED DESCRIPTION OF THE INVENTION

The present invention relates to a lignin-based fuel and a method of producing electricity power from the fuel. The fuel is a mixture of lignin residue derived from enzymatic hydrolysis of biomass feedstocks and natural gas. It has been found that the lignin residue of enzymatic hydrolysis process, and in particular from a SSF process, may be advantageously combined with natural gas as a “clean” fuel for use in gas turbogenerators.

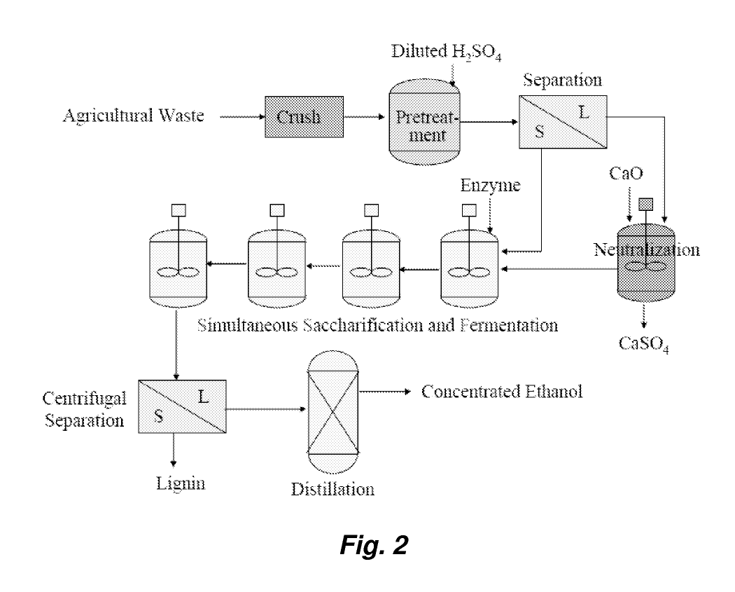

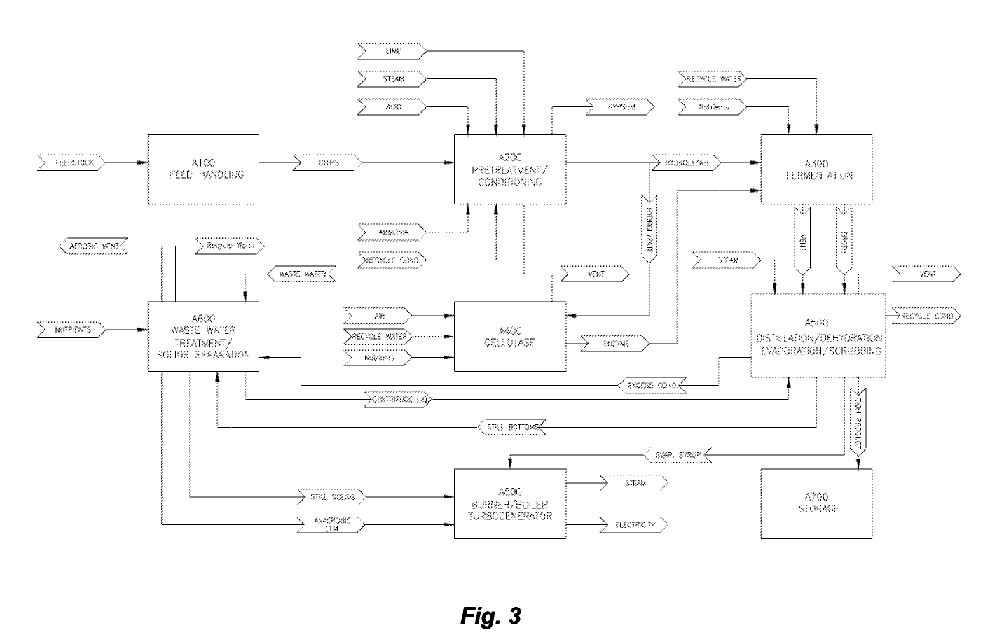

The lignin residue may be generated from known enzymatic hydrolysis processes such as the SSF process developed by NREL. The SSF process can be briefly described as using co-current dilute acid pre-hydrolysis of the lignocellulosic biomass with simultaneous enzymatic saccharification of the remaining cellulose and co-fermentation of the resulting glucose and xylose to ethanol. In addition to these unit operations, the process involves feedstock handling and storage, product purification, wastewater treatment, enzyme production, lignin combustion, product storage, and other utilities. In all, the NREL process is divided into nine areas (see FIGS. 2 and 3). Details of the process can be found in NREL design reports for the dilute acid prehydrolysis and enzymatic hydrolysis process.

The feedstock, such as corn stover or wood wastes, is delivered to the feed handling (A100) area for storage and size reduction. From there, the biomass is conveyed to pretreatment and conditioning (A200). In this area, the biomass is treated with dilute sulfuric acid at a high temperature for a very short time, liberating the hemicellulose sugars and other compounds. Ion exchange and overliming is required to remove compounds liberated in the pretreatment that will be toxic to the fermenting organism. Only the liquid portion of the hydrolysis stream is conditioned.

After pretreatment, a portion of the hydrolyzate slurry is split off to enzyme production (A400). In enzyme production, seed inoculum is grown in a series of progressively larger aerobic batch fermentors. The inoculum is then combined with additional hydrolyzate slurry and nutrients in aerobic fermentors to produce the enzyme needed for saccharification.

Simultaneous saccharification and fermentation, or SSF, (A300) of the hydrolyzate slurry is carried out in a series of continuous anaerobic fermentation trains. The recombinant fermenting organism Zymomonas mobilis is grown in progressively larger batch anaerobic fermentations. This inoculum, along with cellulase enzyme from enzyme production (A400) and other nutrients, is added to the first fermentor. After several days of saccharification and fermentation, most of the cellulose and xylose will have been converted to ethanol. The resulting beer with 4-5% by weight ethanol is sent to product recovery.

Ethanol product recovery (A500) consists of a beer column to distill the ethanol from the majority of the water and residual solids. The vapor exiting the beer column is 35% by weight ethanol and feeds a rectification column. A mixture of nearly azeotropic (92.5%) ethanol and water from the rectification column is purified to pure (99.5%) ethanol using vapor-phase molecular sieves. The beer column bottoms are sent to the first effect of a three-effect evaporator. The rectification column reflux condenser provides heat for this first effect. After the first effect, solids are separated using a centrifuge and dried in a rotary dryer. A portion (25%) of the centrifuge effluent is recycled to fermentation and the rest is sent to the second and third evaporator effects.

Most of the evaporator condensate is returned to the process as fairly clean condensate (a small portion, 10%, is split off to waste water treatment to prevent build-up of low-boiling compounds) and the concentrated syrup contains 15%-20% by weight total solids. Biogas (containing 50% methane, and with a heating value of approximately 12,000 British thermal units, or Btu, per pound) is produced by anaerobic digestion of organic compounds in wastewater treatment. The treated water is considered suitable for recycling and is returned to the process, so there is no water discharge from the process.

The solids from the distillation are primarily lignin residue. After separation and/or drying, the solid lignin byproduct has a moisture content of 20 percent by weight or less, preferably 10 percent by weight or less. The resultant residue has a powdered form with an average particulate size of approximately one micron. The lignin is highly concentrated in the residue. There is minimal impurities (as described above) and these impurities will have a heating value somewhat lower than the lignin.

The lignin residue is particularly useful as a clean fuel in combination with natural gas for gas turbogenerators utilizing a Brayton cycle. The mixture of natural gas and lignin residue is sufficiently clean and non-corrosive that it can be used in a typical gas generator, i.e., at temperatures up to 2100° F. and at entering gas pressures up to about 10-12 atmospheres. The lignin residue is preferably injected in an air suspension into the combustor just ahead of the natural gas to form a combustible mixture at the turbine entrance. The mixture is ignited with heated, pressurized air from the compressor. The resultant high temperature, high pressure gases exit the combustor into the turbine where the gases pass through the turbine vanes, turning the turbine wheel and rotating the turbine shaft. A generator converts the rotational energy of the turbine shaft into usable electrical energy.

The proportion of lignin residue to the overall mixture of lignin/natural gas fuel is preferably between about 2 to 75 percent, more preferably between about 25 to 65 percent, and most preferably between about 40 and 60 percent by weight. It has been found that while wide ranges of lignin residue may be used, high concentration of lignin residue, e.g., in excess of about 75 percent by weight, may adversely affect the operation of the gas turbine. It is believed that the use of the lignin residue in a mixture with natural gas provides higher energy output and/or efficiency for the production of electricity when compared to the use of the same product as a fuel in a boiler to generate electricity in a steam generator. The lignin residue may be mixed with pressurized gas and/or other clean combustible fuels such as ethanol, propane and liquid natural gas.

The lignin residue is transported to a gas turbogenerator. Preferably, the ethanol/lignin residue processing plant is co-located with the power generation plant to facilitate transport to reduce transportation expense. The lignin residue may be transported by any suitable means including, for example, conveyors, tank cars, and pipelines. When the lignin residue is transported by pipe, it is preferred to mix the lignin residue with compressed air.

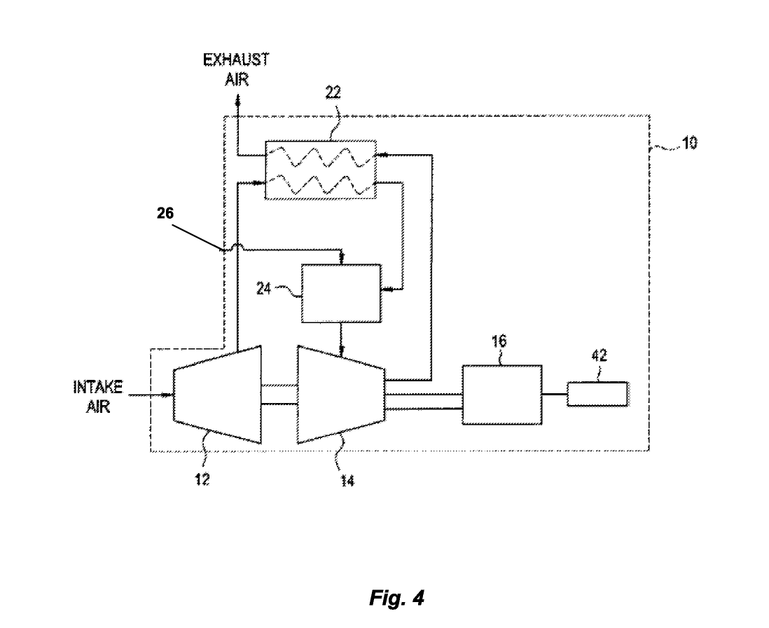

FIG. 4 illustrates an example of a typical gas turbogenerator, such as disclosed in U.S. Pat. No. 6,666,027 which is hereby incorporated by reference, including a turbine power generating system 10, which can be adapted to use the lignin residue/natural gas fuel as described herein. The turbine power generating system 10 includes an air compressor 12, a turbine 14, and an electrical generator 16. The electrical generator 16 is cantilevered from the air compressor 12. The compressor 12, the turbine 14, and the electrical generator 16 can be rotated by a single shaft. Although the air compressor 12, turbine 14, and electrical generator 16 can be mounted to separate shafts, the use of a single common shaft for rotating the air compressor 12, the turbine 14, and the electrical generator 16 adds to the compactness and reliability of the power generating system 10. The shaft typically is supported by self-pressurized air bearings such as foil bearings.

Air entering an inlet of the air compressor 12 is compressed. Compressed air leaving an outlet of the air compressor 12 is circulated through cold side passages in a cold side of a recuperator 22. In the recuperator 22, the compressed air absorbs heat, which enhances combustion. The heated, compressed air leaving the cold side of the recuperator 22 is supplied to a combustor 24.

Fuel is also supplied to the combustor 24. The flow of fuel is controlled by a flow control valve or valves 26. The fuel is injected into the combustor 24. The fuel comprises a lignin residue as defined above and is supplied as described below. The lignin residue may be mixed with pressurized gas, preferably air, and injected into combustor 24. Alternatively, the lignin residue may be mixed directly with the natural gas fuel, either in a separate chamber or at the injection nozzle into the combustor. When the lignin residue fuel and natural gas are injected separately into the combustor, it preferable that the injection nozzle for inputting the natural gas is positioned closer to the gas turbine intake than the injection nozzle for inputting the lignin residue.

Inside the combustor 24, the fuel and compressed air are mixed and ignited by an igniter in an exothermic reaction. The combustor 24 can be any type of premix combustion system, including, but not limited to, catalytic combustors. In one embodiment, the combustor 24 contains a suitable catalyst capable of combusting the compressed, high temperature, fuel-air mixture at the process conditions. Representative examples of catalysts usable in the combustor 24 include platinum, palladium, as well as metal oxide catalyst with active nickel and cobalt elements.

After combustion, hot, expanding gases resulting from the combustion are directed to an inlet nozzle of the turbine 14. The inlet nozzle has a fixed geometry. The hot, expanding gases resulting from the combustion is expanded through the turbine 14, thereby creating turbine power. The turbine power, in turn, drives the air compressor 12 and the electrical generator 16.

Turbine exhaust gas is circulated by hot side passages in a hot side of the recuperator 22. Inside the recuperator 22, heat from the turbine exhaust gas on the hot side is transferred to the compressed air on the cold side. In this manner, some heat of combustion is recuperated and used to raise the temperature of the compressed air en route to the combustor 24. After surrendering part of its heat, the gas exits the recuperator 22. Additional heat recovery stages could be added onto the power generating system 10.

The generator 16 can be a ring-wound, two-pole toothless (TPTL) brushless permanent magnet machine having a permanent magnet rotor and stator windings. The turbine power generated by the rotating turbine 14 is used to rotate the rotor. The rotor is attached to the shaft. When the rotor is rotated by the turbine power, an alternating current is induced in the stator windings. Speed of the turbine can be varied in accordance with external energy demands placed on the system 10. A controller controls the turbine speed by controlling the amount of fuel flowing to the combustor 24. The controller uses sensor signals generated by a sensor group to determine the external demands upon the power generating system 10. The sensor group could include sensors such as position sensors, turbine speed sensors and various temperature and pressure sensors for measuring operating temperatures and pressures in the system 10. Using the aforementioned sensors, the controller controls both startup and optimal performance during steady state operation.

The invention is not limited to the specific embodiments disclosed above. Modifications and variations of the methods and devices described herein will be obvious to those skilled in the art from the foregoing detailed description. Such modifications and variations are intended to come within the scope of the appended claims.

What is claimed is:

1. A method of generating power comprising:
injecting lignin residue derived from the enzymatic hydrolysis of a biomass feedstock and natural gas into a combustor of a gas turbine power generator;
combusting the lignin residue and natural gas with compressed air;
inputting the resultant gases into a gas turbine to rotate a turbine shaft and generate rotational energy; and
converting the rotational energy into electrical energy.

2. The method according to claim 1, wherein the lignin residue is derived from a process of simultaneous sachrification and fermentation of the biomass feedstock.

3. The method according to claim 1, wherein the lignin residue comprises about 2 to about 70 percent by weight of the total amount of lignin residue and natural gas injected into the combustor.

4. The method according to claim 1, wherein the lignin residue comprises about 25 to about 65 percent by weight of the total amount of lignin residue and natural gas injected into the combustor.

5. The method according to claim 1, wherein the lignin residue comprises about 40 to about 60 percent by weight of the total amount of lignin residue and natural gas injected into the combustor.

6. The method according to claim 1, wherein the lignin residue has a moisture content of about 20 percent or less.

7. The method according to claim 1, wherein the lignin residue has a moisture content of about 10 percent or less.

8. The method according to claim 1, further comprising the step of:
transporting the lignin residue to the combustor.

9. The method according to claim 8, wherein the lignin residue is transported with pressurized air.

10. A fuel for use in a gas turbogenerator comprising a mixture of lignin residue derived from the enzymatic hydrolysis of a biomass feedstock and natural gas.

11. The fuel according to claim 10, wherein the lignin residue is derived from a process of simultaneous sachrification and fermentation of the biomass feedstock.

12. The fuel according to claim 10, wherein the lignin residue comprises about 2 to about 70 percent by weight of the total amount of lignin residue and natural gas injected into the combustor.

13. The fuel according to claim 10, wherein the lignin residue comprises about 25 to about 65 percent by weight of the total amount of lignin residue and natural gas injected into the combustor.

14. The fuel according to claim 10, wherein the lignin residue comprises about 40 to about 60 percent by weight of the total amount of lignin residue and natural gas injected into the combustor.

15. The fuel according to claim 10, wherein the lignin residue has a moisture content of about 20 percent or less.

16. The fuel according to claim 10, wherein the lignin residue has a moisture content of about 10 percent or less.
